(19) United States
(12) Patent Application Publication
(10) Pub. No.: US 2017/0169925 A1
(43) Pub. Date: Jun. 15, 2017

(54) Magnetic Pad And Countertop Combination System

(71) Applicant: Daniel T. Cordero, Modesto, CA (US)

(72) Inventor: Daniel T. Cordero, Modesto, CA (US)

(21) Appl. No.: 14/963,569

(22) Filed: Dec. 9, 2015

(51) Int. Cl. H01F 7/02

(52) U.S. Cl. CPC H01F 7/0215; H01F 7/0252

(57) ABSTRACT

A magnetic pad and countertop combination system includes a countertop that has an upper surface supported above a floor surface. A pad is positioned on the upper surface and is comprised of magnetic material for retaining magnetically attracted objects on the pad and thereby retaining these objects on the countertop.

### BACKGROUND OF THE DISCLOSURE

Field of the Disclosure

The disclosure relates to tool and fastener retention devices and more particularly pertains to a new tool and fastener retention device for preventing metallic tools and fasteners from rolling off of a workbench or other countertop.

### SUMMARY OF THE DISCLOSURE

An embodiment of the disclosure meets the needs presented above by generally comprising a countertop that has an upper surface supported above a floor surface. A pad is positioned on the upper surface and is comprised of magnetic material configured to retain magnetically attracted objects on the pad.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a magnetic pad and countertop combination system according to an embodiment of the disclosure.

FIG. 2 is a bottom view of a pad of an embodiment of the disclosure.

FIG. 3 is a cross-sectional view of an embodiment of the disclosure taken along line 3-3 of FIG. 2.

FIG. 4 is a top perspective view of an embodiment of the disclosure.

### DESCRIPTION OF THE PREFERRED EMBODIMENT

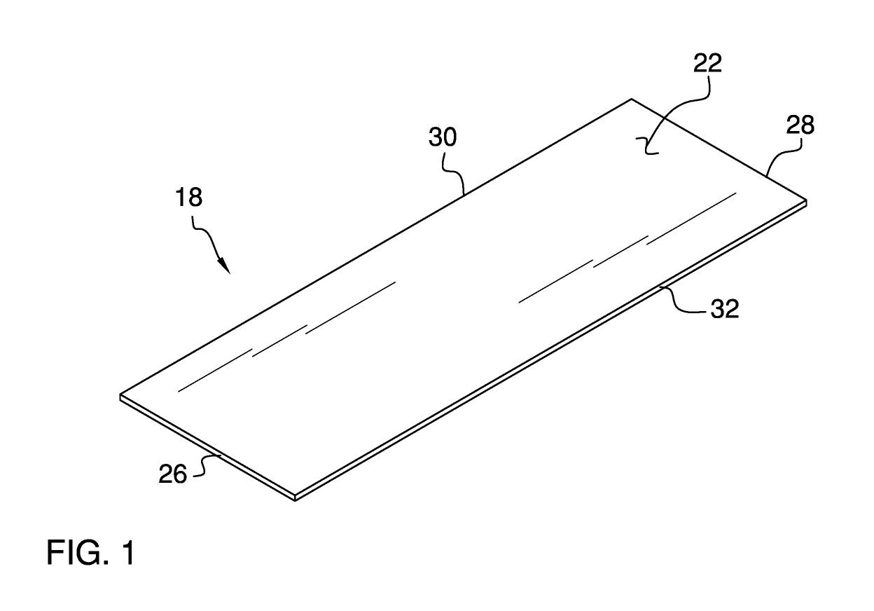

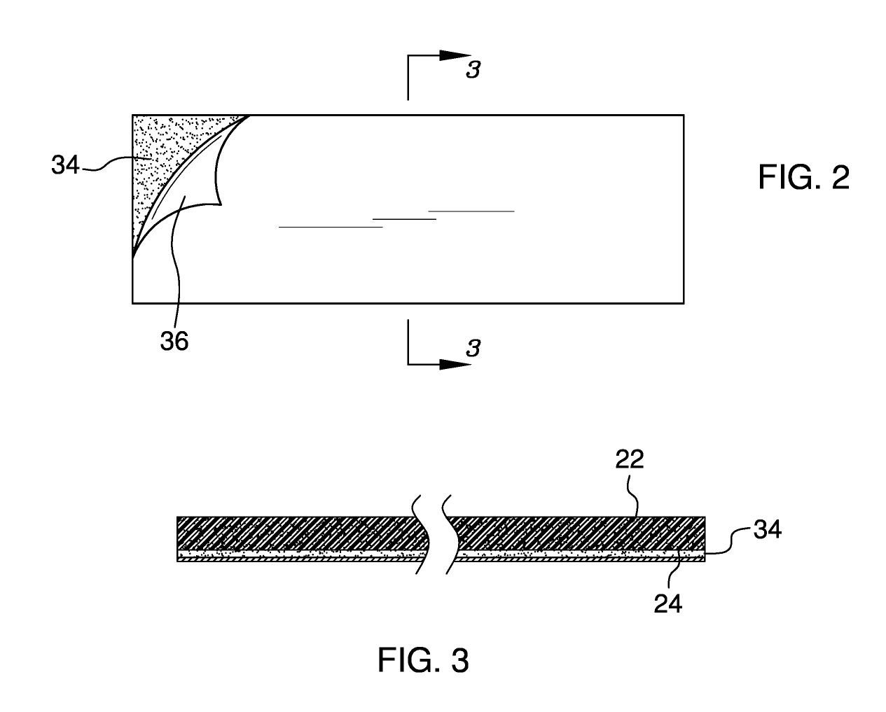

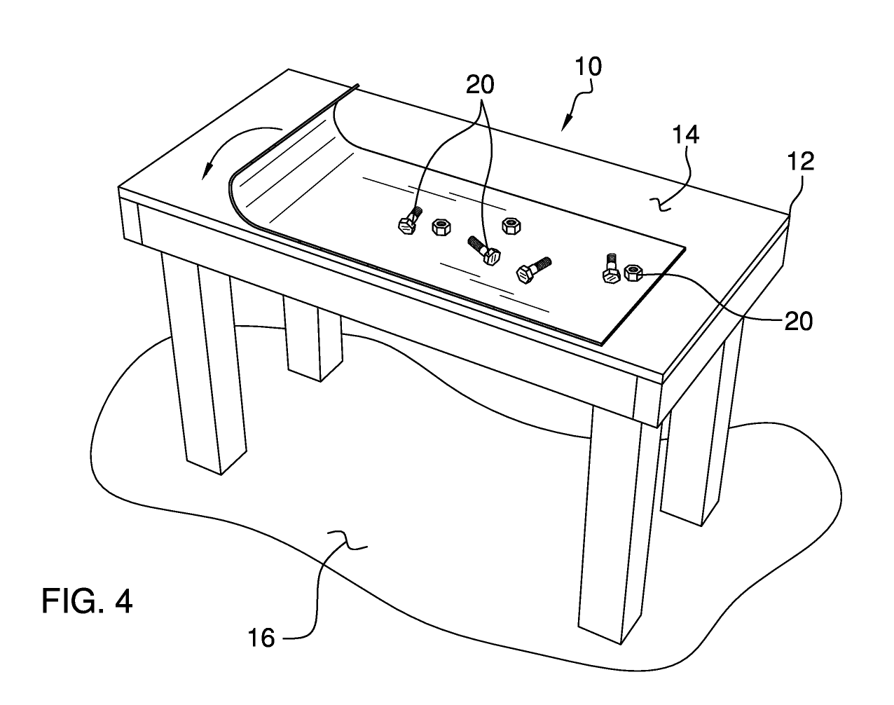

With reference now to the drawings, and in particular to FIGS. 1 through 4 thereof, a new tool and fastener retention device embodying the principles and concepts of an embodiment of the disclosure and generally designated by the reference numeral 10 will be described.

As best illustrated in FIGS. 1 through 4, the magnetic pad and countertop combination system 10 generally comprises a countertop 12 having an upper surface 14 supported above a floor surface 16. The countertop 12 may be one that is affixed to a table as is shown in FIG. 4, a workbench, or a built in type cabinet top as one might find in a work area with tools.

A pad 18 is positioned on the upper surface 14 and is comprised of magnetic material configured to retain magnetically attracted objects 20 on the pad 18. The pad 18 is resiliently flexible and may comprise an elastomeric material. The pad 18 is thus comfortable to work on due to its resiliently compressible structure. The pad 18 has a top side 22 and a bottom side 24 wherein the top side 22 faces away from the countertop 12. The top side 22 has an area greater than 3.5 ft² and will typically have an area less than 12.0 ft² and more particularly less than 9.0 ft². However, the pad 18 may be cut to size by the end user of the system 10. The pad 18 has a height from the top side 22 to the bottom side 24 that is between 0.25 inches and 1.0 inches. The pad 18 may have a first end edge 26, a second end edge 28, a first lateral edge 30 and a second lateral edge 32 such that the pad 18 has a rectangular shape.

An adhesive 34 is positioned on the bottom side 24 of the pad 18 and releasably secures the pad 18 to the upper surface 14. The adhesive 34 may be a conventional pressure sensitive adhesive. Additionally, a backing 36 may be positioned over the adhesive 34 to protect the adhesive 34 until it is needed. The backing 36 is removed from the adhesive 34 before attachment of the pad 18 to the countertop 12.

In use, the pad 18 it attached to the countertop 12 as described above wherein the adhesive 34 may or may not be utilized. When metallic tools and fasteners, or magnetically attracted objects 20, are placed upon the pad 18, its magnetic properties prevents these items from rolling and from falling off of the countertop 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A magnetic pad and support surface combination system:
a countertop having an upper surface supported above a floor surface; and
a pad being positioned on said upper surface, said pad being comprised of magnetic material configured to retain magnetically attracted objects on said pad, said pad has a top side and a bottom side wherein said top side faces away from said countertop, said top side having an area greater than 3.5 ft²; and
an adhesive being positioned on said bottom side of said pad and releasably securing said pad to said upper surface.

2. The magnetic pad and support surface combination system according to claim 1, wherein said pad is resiliently flexible.

3. The magnetic pad and support surface combination system according to claim 2, wherein said pad comprises an elastomeric material.

4. (canceled)

5. The magnetic pad and support surface combination system according to claim 1, wherein said pad has a height from said top side to said bottom side being between 0.25 inches and 1.0 inches.

6. (canceled)

7. The magnetic pad and support surface combination system according to claim 2, wherein said pad has a top side and a bottom side wherein said top side faces away from said countertop, including an adhesive being positioned on said bottom side of said pad and releasably securing said pad to said upper surface.

8. (canceled)

9. A magnetic pad and support surface combination system:
a countertop having an upper surface supported above a floor surface;
a pad being positioned on said upper surface, said pad being comprised of magnetic material configured to retain magnetically attracted objects on said pad, said pad being resiliently flexible, said pad comprising an elastomeric material, said pad having a top side and a bottom side wherein said top side faces away from said countertop, said top side having an area greater than 3.5 ft², said pad having a height from said top side to said bottom side being between 0.25 inches and 1.0 inches, said pad having a first end edge, a second end edge, a first lateral edge and a second lateral edge and having a rectangular shape; and
an adhesive being positioned on said bottom side of said pad and releasably securing said pad to said upper surface.
